(19) United States
(12) Patent Application Publication
(10) Pub. No.: US 2020/0103071 A1
(43) Pub. Date: Apr. 2, 2020

(54) Telescopic mobile electronic device support

(71) Applicant: Pengcheng DU, Guangdong (CN)

(72) Inventor: Pengcheng DU, Guangdong (CN)

(21) Appl. No.: 16/217,058

(22) Filed: Dec. 12, 2018

(30) Foreign Application Priority Data
Sep. 29, 2018 (CN) 201821602472.4

(51) Int. Cl. F16M 11/14; F16M 11/28; B60R 11/02

(52) U.S. Cl. CPC F16M 11/14; B60R 2011/008; B60R 11/02; F16M 11/28

(57) ABSTRACT

A telescopic mobile electronic device support, including a pedestal on which a housing is mounted, a telescopic movable rod and a telescopic sleeve arranged thereon. The telescopic sleeve and the telescopic movable rod are mounted in the housing. The telescopic sleeve is provided with ball screws. The telescopic movable rod is provided with limiting grooves. The ball screws abut the limiting grooves. The steel balls of the two ball screws are pressed to move inwards when the telescopic movable rod slides. When aligned with the limiting grooves on the telescopic movable rod, the steel balls will eject to support the limiting grooves and fix the position of the telescopic movable rod. The limiting grooves on the telescopic movable rod abut the steel balls for limiting, to adjust the distance of the telescopic movable rod.

### BACKGROUND OF THE INVENTION

The utility model relates to the field of mobile electronic device supports, and in particular to a telescopic mobile electronic device support.

Since automobiles and mobile electronic devices are popularized and many mobile electronic devices have multiple functions including navigation, a support for conveniently placing the mobile electronic device in the automobile arises. Currently, traditional mobile electronic device supports on the market are generally fixed in automobiles with a sucking disc or in a way of being inserted into the air outlet inside automobiles for the user to use. Due to different personal using habits and purposes, the angle of the mobile electronic device often needs adjustment for the user to use. The support is usually designed to include a pedestal provided with a connecting rod, the connecting rod is fixedly provided with a universal ball on which a clamping part for clamping the electronic mobile device is mounted, and the electronic mobile device is placed in the clamping part for use. However, in the actual use process, simply adjusting the angle cannot satisfy consumers' need completely. Due to the height and driving habit, and uncertain plane position for placing the support in each vehicle, it needs to realize adjustment of near-far and up-down position of the mobile electronic device and the driver by simply adjusting the support, and the current support cannot satisfy such a need.

### BRIEF SUMMARY OF THE INVENTION

The utility model aims to overcome the shortages of the prior art and provide a telescopic mobile electronic device support that can realize adjustments of near-far and up-down positions of the mobile electronic device in relation to the driver by adjusting the support. In order to realize the above purpose, the utility model adopts the following technical solution:

A telescopic mobile electronic device support includes a pedestal, wherein, the support includes a housing, a telescopic sleeve and a telescopic movable rod; the housing is mounted on the pedestal; the telescopic sleeve is arranged on the telescopic movable rod, and both the telescopic sleeve and the telescopic movable rod are mounted in the housing; the telescopic sleeve is provided with ball screws; the telescopic movable rod is provided with limiting grooves; and the ball screws abut the limiting grooves.

Preferably, the housing is movably mounted on the pedestal through a screw and nuts in a locking way;

Preferably, the housing is provided with a mounting hole; two parallel support arms are arranged on the pedestal and provided with a screw hole in corresponding positions; the housing is located between the two parallel support arms; the screw passes through the screw holes in the two support arms and the mounting hole in the housing, and the housing is movably fixed on the pedestal by the screw and the nuts in a locking way;

Preferably, the joining parts between the housing and the two support arms of the pedestal are provided with an anti-slip socket; and the anti-slip sockets in the housing are engaged with the anti-slip sockets in the support arms;

Preferably, the screw is provided with a handheld rotating part; and the locking force between the screw and the nuts is adjusted by the handheld rotating part to adjust the angle between the housing and the pedestal;

Preferably, the telescopic sleeve is provided with a fixture block, the housing is provided with a bayonet, and the telescopic sleeve sticks in the bayonet of the housing through the fixture block;

Preferably, the telescopic sleeve is provided with two ball screws, the telescopic movable rod is provided with several limiting grooves arranged at equal intervals; and the two ball screws simultaneously abut two of the several limiting grooves in the telescopic movable rod for limiting;

Preferably, the pedestal is provided with a sucking disc;

Preferably, the telescopic movable rod is provided with four stop legs at one end and a universal ball at the other end for mounting a clamping part; and the four stop legs are capable of being stopped by one end of the telescopic sleeve;

Preferably, the housing is provided with four sliding grooves inside, and the four stop legs arranged at one end of the telescopic movable rod are located in the four sliding grooves respectively and slide back and forth to lengthen and retract in the sliding grooves.

In the using process, the sucking disc arranged on the pedestal is used to fix the support in a preset position; the mobile electronic device is placed in the clamping part mounted on the universal ball of the telescopic movable rod; the fixture block on the telescopic sleeve is connected with the bayonet of the housing, so that the telescopic movable rod lengthens and retracts back and forth in the telescopic sleeve and the housing; the four stop legs arranged on the telescopic movable rod are stop blocks projecting outward that can be stopped by one end of the telescopic sleeve to prevent the telescopic movable rod from being pulled out away from the telescopic sleeve and the housing; the four stop legs move in the four sliding grooves in the housing and further guarantee the smoothness and stability of sliding back and forth of the telescopic movable rod; the telescopic sleeve is provided with two ball screws inside; the telescopic movable rod is placed in the telescopic sleeve first, and then both the telescopic movable rod and the telescopic sleeve are placed in the housing; the telescopic movable rod slides back and forth through the telescopic sleeve; the steel balls of the two ball screws in the telescopic sleeve are pressed to retract inwards when the telescopic movable rod slides; when the limiting grooves on the telescopic movable rod are aligned, the steel balls will eject to support the limiting grooves and fix the position of the telescopic movable rod; several limiting grooves arranged at equal intervals on the telescopic movable rod abut the steel balls of the two ball screws for limiting, to adjust the distance of the telescopic movable rod so as to retract immediately, fast and stably, thereby realizing adjusting the far-near visual distance between the mobile electronic device and the user; the housing is mounted on the pedestal in a way of fastening through the nuts of the screw; connection can be loosened by the handheld rotating part on the screw to adjust the combining angle between the housing and the pedestal, and the screw and the nuts are locked after adjusting to an appropriate angle; the anti-slip sockets of the joining parts between the housing and the support arms of the pedestal are engaged with each other to prevent angle offset, thereby realizing the purpose of adjusting the angle up and down.

The utility model will be further described below in combination with the attached drawings and specific embodiments.

### BRIEF DESCRIPTION OF THE DRAWINGS

FIG. 1 is a schematic diagram of the overall structure of the utility model;

FIG. 2 is an exploded schematic diagram of components of the utility model;

FIG. 3 is a structural schematic diagram of the telescopic movable rod, telescopic sleeve and housing of the utility model;

FIG. 4 is a cutaway view of the telescopic movable rod, telescopic sleeve and housing of the utility model;

FIG. 5 is a working state diagram 1 of the utility model; and

FIG. 6 is a working state diagram 2 of the utility model.

### DETAILED DESCRIPTION OF THE INVENTION

To clarify the objective, technical solution and advantages of the utility model, the utility model will be further detailed below in conjunction with the drawings and embodiments. It should be understood that the specific embodiments described here are only used for explaining rather than limiting the utility model.

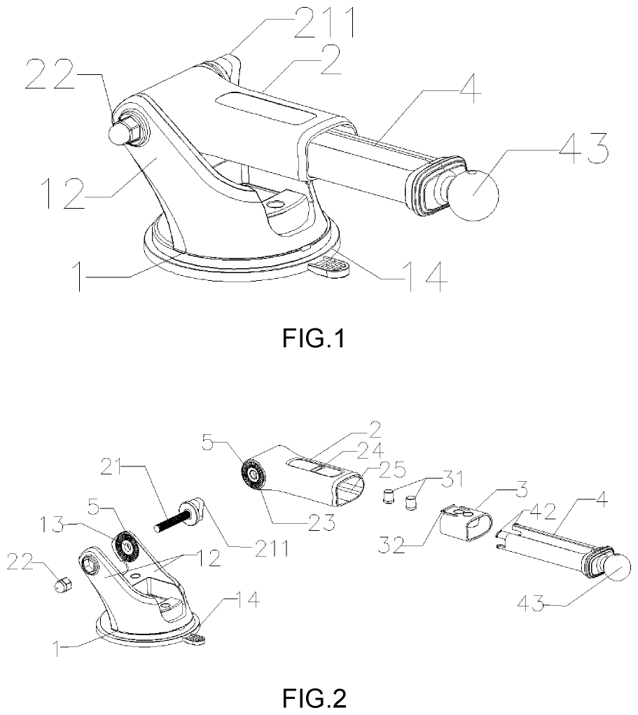

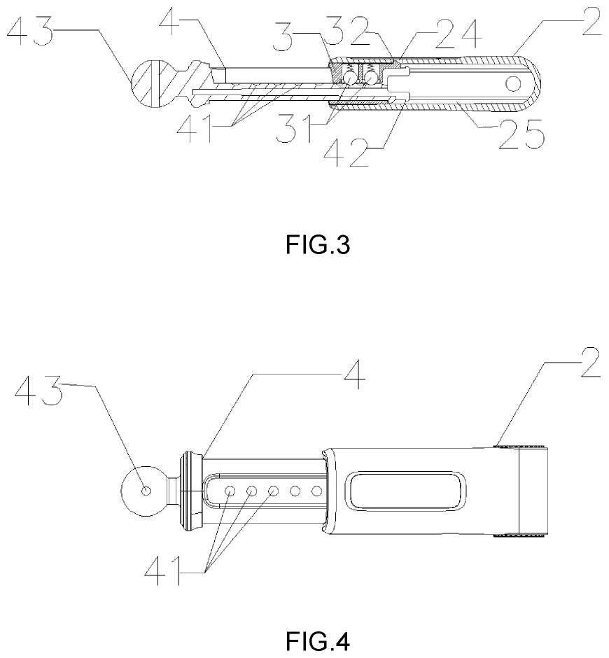

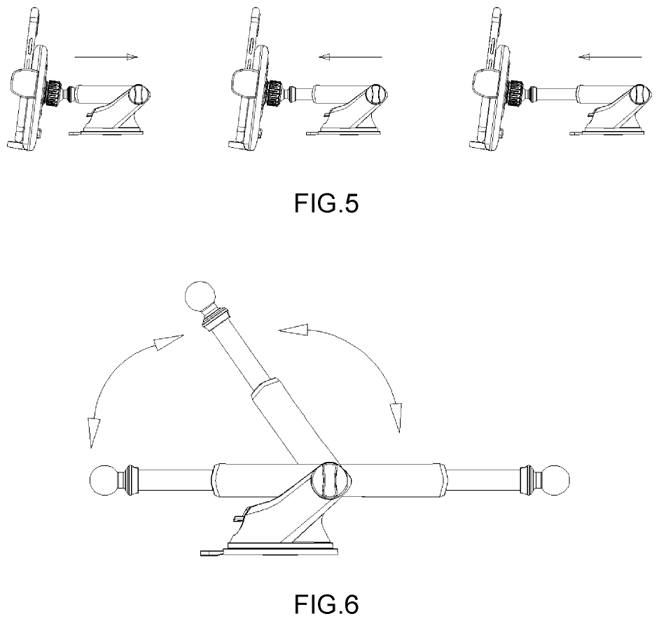

As shown in FIGS. 1 to 6, in a specific embodiment of the utility model, a telescopic mobile electronic device support includes a pedestal 1, wherein, the support includes a housing 2, a telescopic sleeve 3 and a telescopic movable rod 4; the housing 2 is mounted on the pedestal 1; the telescopic sleeve 3 is arranged on the telescopic movable rod 4, and both the telescopic sleeve and the telescopic movable rod are mounted in the housing 2; the telescopic sleeve 3 is provided with ball screws 31; the telescopic movable rod 4 is provided with limiting grooves 41; and the ball screws 31 abut the limiting grooves 41.

Preferably, the housing 2 is movably mounted on the pedestal 1 through a screw 21 and nuts 22 in a locking way;

Preferably, the housing 2 is provided with a mounting hole 23; two parallel support arms 12 are arranged on the pedestal 1 and provided with a screw hole 13 in corresponding positions; the housing 2 is located between the two parallel support arms 12; the screw 21 passes through the screw holes 13 in the two support arms 12 and the mounting hole 23 in the housing 2, and the housing 2 is movably fixed on the pedestal 1 by the screw and the nuts 22 in a locking way;

Preferably, the joining parts between the housing 2 and the two support arms 12 of the pedestal are provided with an anti-slip socket 5; and the anti-slip sockets 5 in the housing 2 are engaged with the anti-slip sockets 5 in the support arms 12;

Preferably, the screw 21 is provided with a handheld rotating part 211; and a locking force between the screw 21 and the nuts 22 is adjusted by the handheld rotating part 211 to adjust the angle between the housing 2 and the pedestal 1;

Preferably, the telescopic sleeve 3 is provided with a fixture block 32, the housing 2 is provided with a bayonet 24, and the telescopic sleeve 3 sticks in the bayonet 24 of the housing 2 through the fixture block 32;

Preferably, the telescopic sleeve 3 is provided with two ball screws 31, the telescopic movable rod 4 is provided with several limiting grooves 41 arranged at equal intervals; and the two ball screws 31 abut two of the several limiting grooves 41 in the telescopic movable rod 4 simultaneously for limiting;

Preferably, the pedestal 1 is provided with a sucking disc 14;

Preferably, the telescopic movable rod 4 is provided with four stop legs 42 at one end and with a universal ball 43 at the other end for mounting a clamping part; and the four stop legs 42 are capable of being stopped by one end of the telescopic sleeve 3;

Preferably, the housing 2 is provided with four sliding grooves 25 inside, and the four stop legs 42 arranged at one end of the telescopic movable rod 4 are located in the four sliding grooves 25 respectively and slide back and forth to lengthen and retract in the sliding grooves 25.

In the using process, the sucking disc 14 arranged on the pedestal 1 is used to fix the support in a preset position; the mobile electronic device is placed in the clamping part 44 mounted on the universal ball 43 of the telescopic movable rod 4; the fixture block 32 on the telescopic sleeve 3 is connected with the bayonet 24 of the housing 2, so that the telescopic movable rod 4 lengthens and retracts back and forth in the telescopic sleeve 3 and the housing 2; the four stop legs 42 arranged on the telescopic movable rod 4 are stop blocks projecting outward that can be stopped by one end of the telescopic sleeve 3 to prevent the telescopic movable rod 4 from being pulled out away from the telescopic sleeve 4 and the housing 2; the four stop legs 42 move in the four sliding grooves 25 in the housing 2 and further guarantee the smoothness and stability of sliding back and forth of the telescopic movable rod 4; the telescopic sleeve 3 is provided with two ball screws 31 inside; the telescopic movable rod 4 is first placed in the telescopic sleeve 3 and then both the telescopic movable rod and the telescopic sleeve are placed in the housing 2; the telescopic movable rod 4 slides back and forth through the telescopic sleeve 3; steel balls of two ball screws 31 in the telescopic sleeve 3 are pressed to retract inwards when the telescopic movable rod 4 slides; when the limit recess 41 on the telescopic movable rod 4 is aligned, the steel balls will eject to support the limit recess 41 and fix the position of the telescopic movable rod 4; several limiting grooves 41 arranged at equal intervals on the telescopic movable rod 4 abut the steel balls of two ball screws 31 for limiting, to adjust the distance of the telescopic movable rod 4 so as to retract immediately, fast and stably, thereby realizing adjusting far-near visual distance between the mobile electronic device and the user; the housing 2 is mounted on the pedestal 1 in a way of fastening through the nut 22 of the screw 21; connection can be loosened by the handheld rotating part 211 on the screw 21 to adjust the combining angle between the housing 2 and the pedestal 1, and the screw 21 and the nuts 22 are locked after adjusting to an appropriate angle; the anti-slip sockets 5 of the joining parts between the housing 2 and the support arms of the pedestal 1 are engaged with each other to prevent angle offset, thereby realizing the purpose of adjusting the angle up and down.

The foregoing are merely preferred embodiments of the utility model, without the intention of limiting the utility model, and any modification, equivalent substitution and improvement within the spirit and principles of the utility model shall be encompassed in the scope of protection of the utility model.

1: A telescopic mobile electronic device support, comprising a pedestal, wherein, the support comprises a housing, a telescopic sleeve and a telescopic movable rod; the housing is mounted on the pedestal; the telescopic sleeve is arranged on the telescopic movable rod, and both the telescopic sleeve and the telescopic movable rod are mounted in the housing; the telescopic sleeve is provided with pins; the telescopic movable rod is provided with limiting grooves; and the pins abut the limiting grooves.

2: The telescopic mobile electronic device support according to claim 1, wherein, the housing is movably mounted on the pedestal through a screw and nuts in a locking way.

3: The telescopic mobile electronic device support according to claim 2, wherein, the housing is provided with mounting holes; two parallel support arms are arranged on the pedestal and provided with a screw hole in corresponding positions; the housing is located between the two parallel support arms; the screw passes through the screw holes in the two support arms and the mounting hole in the housing, and the housing is movably fixed on the pedestal by the screw and the nuts in a locking way.

4: The telescopic mobile electronic device support according to claim 3, wherein, the joining parts between the housing and the two support arms of the pedestal are provided with an anti-slip socket; and the anti-slip sockets in the housing are engaged with the anti-slip sockets on the support arms.

5: The telescopic mobile electronic device support according to claim 3, wherein, the screw is provided with a handheld rotating part; and the locking force between the screw and the nuts is adjusted by the handheld rotating part to adjust the angle between the housing and the pedestal.

6: The telescopic mobile electronic device support according to claim 1, wherein, the telescopic sleeve is provided with a fixture block, the housing is provided with a bayonet, and the telescopic sleeve sticks in the bayonet of the housing through the fixture block.

7: The telescopic mobile electronic device support according to claim 1, wherein, the telescopic sleeve is provided with two pins, the telescopic movable rod is provided with several limiting grooves arranged at equal intervals; and the two simultaneously abut two of the several limiting grooves in the telescopic movable rod for limiting.

8: The telescopic mobile electronic device support according to claim 1, wherein, the pedestal is provided with a sucking disc.

9: The telescopic mobile electronic device support according to claim 1, wherein, the telescopic movable rod is provided with four stop legs at one end and with a universal ball at the other end for mounting a clamping part; and the four stop legs are capable of being stopped by one end of the telescopic sleeve.

10: The telescopic mobile electronic device support according to claim 9, wherein, the housing is provided with four sliding grooves therein, and the four stop legs arranged at one end of the telescopic movable rod are located in the four sliding grooves respectively and slide back and forth to lengthen and retract in the sliding grooves.
